(19) United States
(12) Patent Application Publication
(10) Pub. No.: US 2011/0145719 A1
(43) Pub. Date: Jun. 16, 2011

(54) PEOPLE RECOMMENDATION INDICATOR METHOD AND APPARATUS IN A SOCIAL NETWORKING SITE

(75) Inventors: Jilin Chen, Minneapolis, MN (US); Casey Dugan, Medford, MA (US); Weyner Geyer, Boston, MA (US); Michael Muller, Medford, MA (US)

(73) Assignee: INTERNATIONAL BUSINESS MACHINES CORPORATION, Armonk, NY (US)

(21) Appl. No.: 12/637,479

(22) Filed: Dec. 14, 2009

(51) Int. Cl. G06F 3/048; G06F 15/16

(52) U.S. Cl. 715/739

(57) ABSTRACT

An indicator method and system recommends people in a computerized social networking site. Indicators in a user interface indicate user-relatedness and/or connectedness information between a given user and other people of the social networking site. The user interface employs the indicators to consistently make people recommendations to the given user. The indicators may be visual including symbolic, graphically illustrative and recommendation score (extent) indicating. The user interface places and displays the indicator at each occurrence of the recommended person's name and/or image throughout each pertinent screen view/page of the social networking site.

### BACKGROUND

There exist a growing number of computer-based social networking sites available today. As the number of users on these sites grows, it becomes difficult for an individual to find others he/she may know or would like to network with. The number of participants in such sites can be enormous, and users may have difficulty recognizing when they are viewing materials by someone they know, or someone whom they should get to know.

One possible way to help users recognize other people on the site is to take advantage of the “friend” or “connection” network data that is recorded at the site. For example, when a user is viewing material from someone they know, the system may indicate the owner of the viewed material is a known colleague or connection already. This simple kind of direct connection indication/indicator exists in the art.

A second possible way to help users find people on sites with a large population is to proactively recommend people to a given user. Facebook™ (by Facebook of Palo Alto, Calif.) has recently added a “People you may know” page. The Facebook system uses a simple “Friend of a Friend” algorithm to recommend people to an end-user, which recommends users based on the number of mutual friends the end-user has in common. On Beehive, a social networking site within IBM (assignee), there is also a people recommendation feature. On Facebook, there is a page dedicated to these people recommendations, while in Beehive, there is a dedicated area on a user's home page that shows a recommended person.

However, by showing people recommendations to a user in only one place on a social networking site, this limits the visibility of the recommendations. Further, a user does not receive this information at the time a possible interaction may take place (for example, when the user is viewing another user's photo and deciding whether or not to leave a comment, or when browsing another user's profile and deciding whether to connect).

Assignee in U.S. Patent Publication No. 2009/0187624 (published Jul. 23, 2009) entitled “User Pivot Navigation of Shared Social Media” describes providing a single and consistent screen/page location for information about the owner of material viewed in a social-networking site.

Assignee in U.S. Patent Publication No. 2009/0187865 (published Jul. 23, 2009) entitled “Site-Wide Navigation Element for User Activity in a Social Networking Site” describes providing a single and consistent screen/page location for indicators of recent activity in a social-networking site.

In U.S. Patent Publication No. 2004/0122681 (published Jun. 24, 2004) entitled “Displaying Strengths of Social Relationships between a User and Other People”, assignee provides a method and indicators for displaying strengths of social relationships between users of a computerized network.

### BRIEF SUMMARY

The present invention addresses these weaknesses in the prior art by providing a recommendation system and method for consistently indicating network relationships to users of a social networking system. These network relationships may take the form of “whom you know” (existing network relationships) and/or “whom you ought to know” (recommended new relationships).

In particular, the present invention goes beyond U.S. Patent Publication Nos. 2009/018624 and 2009/0187865 (cited above) by using social connectedness information across the user interface as opposed to a single screen/page location. The present invention also differs from U.S. Patent Publication No. 2004/0122681 (cited above) in that the present invention is a recommendation system. Multiple algorithms can be used to create recommendations within the system, and each algorithm can lead to different scores. Embodiments of the present invention consistently display the recommendation score or similarity everywhere a user is shown (by name, photo/image or otherwise) across the social networking site (i.e., in the user interface). Such use and display of the social-connectedness information in the user-interface is key to the present invention.

Embodiments propose and provide visual indicators across a social networking site to highlight the social relationship of the user to other persons, including people recommended to a user by a recommendation system. These indicators would appear wherever a user's name or picture appears across the site, for example, in another user's profile page, next to a comment written by the user, on pages with content that the user has created, etc.

The present invention is not directed to a specific algorithm for determining social network-relatedness. One of the simplest ways to determine network-relatedness is to analyze the “friend” or “connection” records of the social-networking site, and to use that information to determine whether the current user has a direct link to the user whose content is currently being viewed. Additional algorithms could determine less direct relationships, such as “friend of a friend” or “one degree of separation.” Such network based algorithms could represent relatedness information as being the number of people (“nodes”) along the shortest social-networking path between the user and person whose content is viewed (for example, a value of “0” is a direct connection, value of “1” indicates a connection with at least one person who has a connection to the person whose content is viewed, etc). Still other algorithms, such as content-based algorithms could determine similarity scores between pairs of users based on the number of words/terms/topics or other content the two users have in common.

Likewise, the present invention is not directed to how the people recommendations are computed (they may be computed algorithmically or manually created by other members, etc), but to a pervasive system of indicating those recommendations across a social networking site.

In one embodiment, a computer system, method or apparatus has a user interface enabling user navigation in and interaction with a computerized social networking site. The user interface employs an indicator indicating user relatedness or connectedness information between a given user and other people of the social networking site. The user interface employs the indicator in a manner consistently making people recommendations to the given user throughout pages of the site.

In accordance with aspects of the present invention, the indicator is any of a visual indication (indicia), an audible indication (e.g., chime or other sound signal), or combination thereof. The indicator may include any of: a symbol, a graphical illustration and a recommendation score. In one embodiment, the graphical illustration is a finable gauge or bar type graph. The indicator may include colorizing, changing size of displayed image, text and/or other page element, and changing shape or border of a displayed element. The indicator may include changing text treatment, such as italicizing, bolding, underlining and the like.

In some embodiments, the indicator includes indicating degree of or extent of user connectedness to other people in the social networking site.

### BRIEF DESCRIPTION OF THE SEVERAL VIEWS OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic view of a computer-network embodying the present invention.

FIG. 2 is a block diagram of a computer node in the network of FIG. 1.

FIGS. 3A and 3B are partially exploded, schematic illustrations of a user interface using social-connectedness information in an embodiment of the present invention.

FIG. 4 is a flow diagram of the embodiment of FIGS. 3A-3B supporting user interface display of social connectedness information.

### DETAILED DESCRIPTION

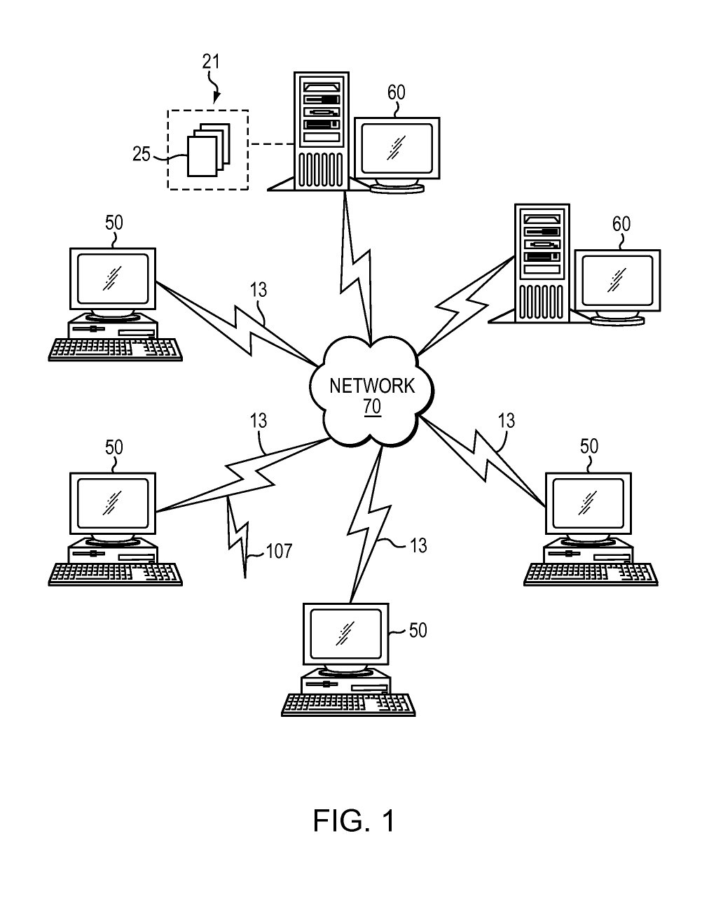

FIG. 1 illustrates a computer network or similar digital processing environment in which the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

In particular, server(s) 60 host a computerized social networking site 21. The social networking site 21 is formed of a collection of pages 25, each viewable in screen views of a client user interface 13 on request of a client user 50. That is, a user of a client 50 logs into social networking site 21 through the user interface 13 running on client 50. The user interface 13 enables client user 50 to navigate through the social networking site 21 using known technology (i.e., browser technology, cursor control technology, window technology and so on).

Different user initiated or otherwise selected operations in user interface 13 make respective requests (commands) of host server(s) 60. In response, server(s) 60 serve or otherwise transmit to and generate on user client 50 one or more pages 25 of social networking site 21. The user interface 13 displays the served pages in respective screen views to client user 50.

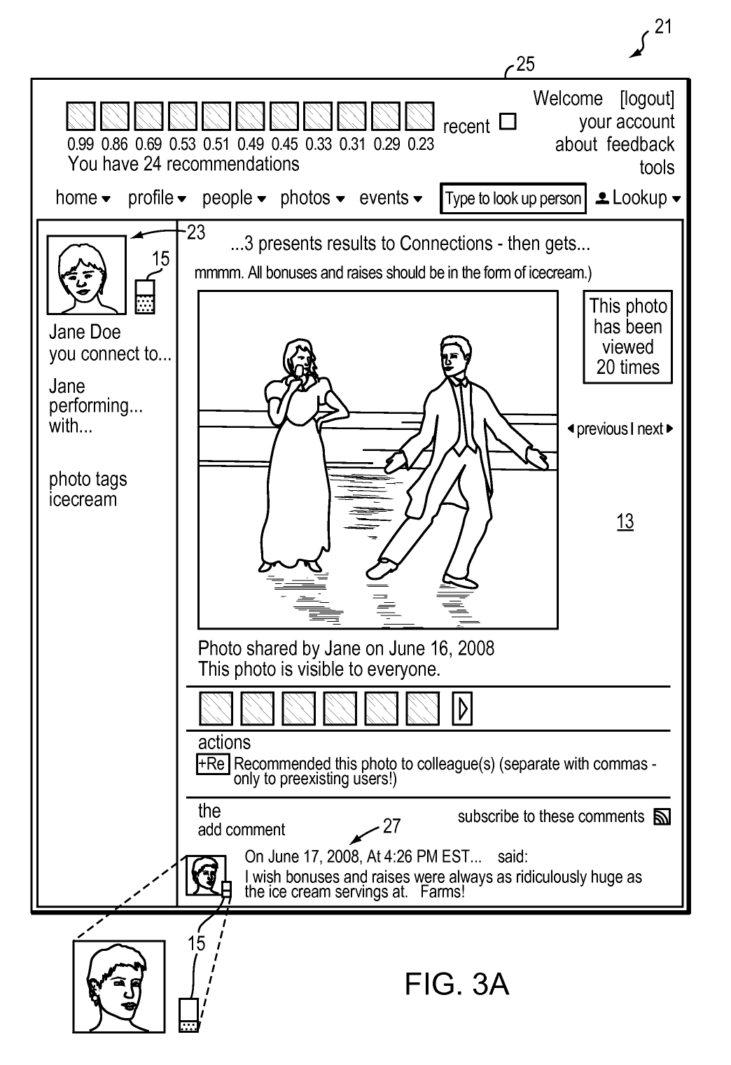

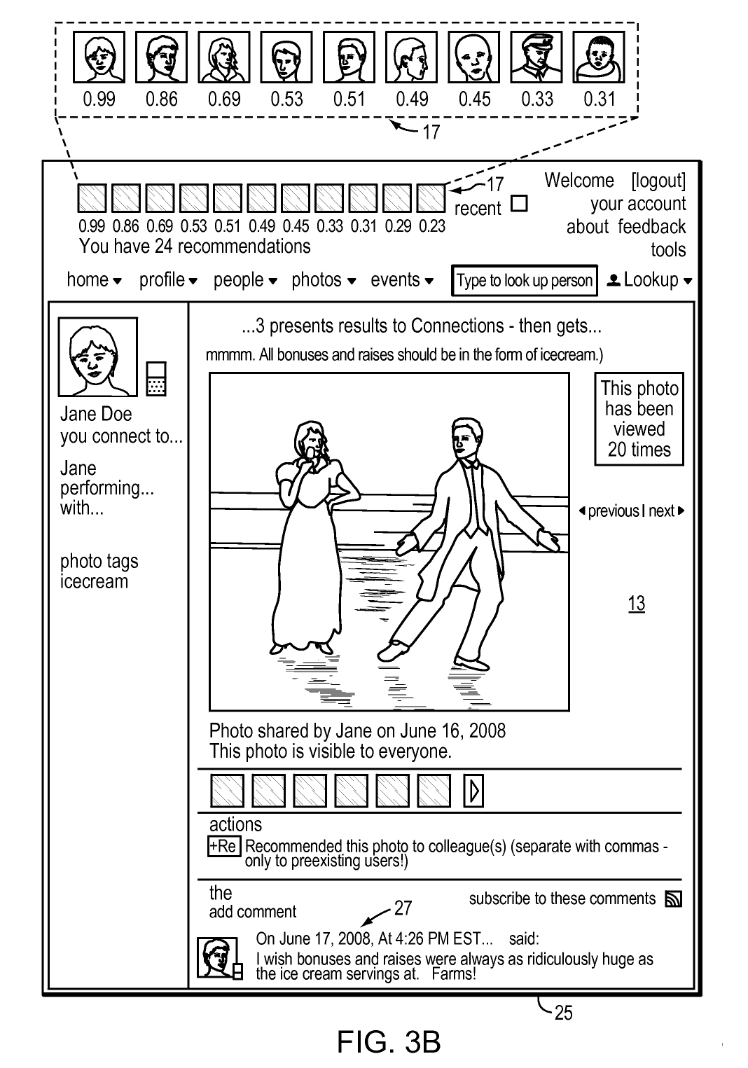

Embodiments of the present invention add to user interface 13 indicators 15, 17 (FIGS. 3A-3B) indicating user relatedness information (including people recommended to a user 50) consistently in various displayed pages/screen views 25. As will be made clear below, the indicators 15, 17 may be visual, audible or any combination thereof. The visual indicators may employ a symbol, a graphical illustration, a recommendation score, a color scheme or colorizing, and/or display formatting (such as resizing of objects, images, font of text; or changing of font type and font treatment—bolding, italicizing, underlining; or changing of shapes or borders of objects, images, etc.), or the like.

In a preferred embodiment, the user interface 13 uses and displays a visual indicator 15, 17 that graphically illustrates extent of user relatedness and of the people recommendation (recommendation of other users to client user 50). The visual indicator 15, 17 is for example a bar graph or numerical score or symbolic score/level. With regard to consistency of display, user interface 13 displays/renders the indicator 15 (recommendation score 17) everywhere an image/photo or the name of a recommended user is shown or named in a page displayed in a screen view to client user 50. This may be multiple places (locations) on a given page/screen view 25 as well as across many pages/screen views throughout the user session on the social networking site 21.

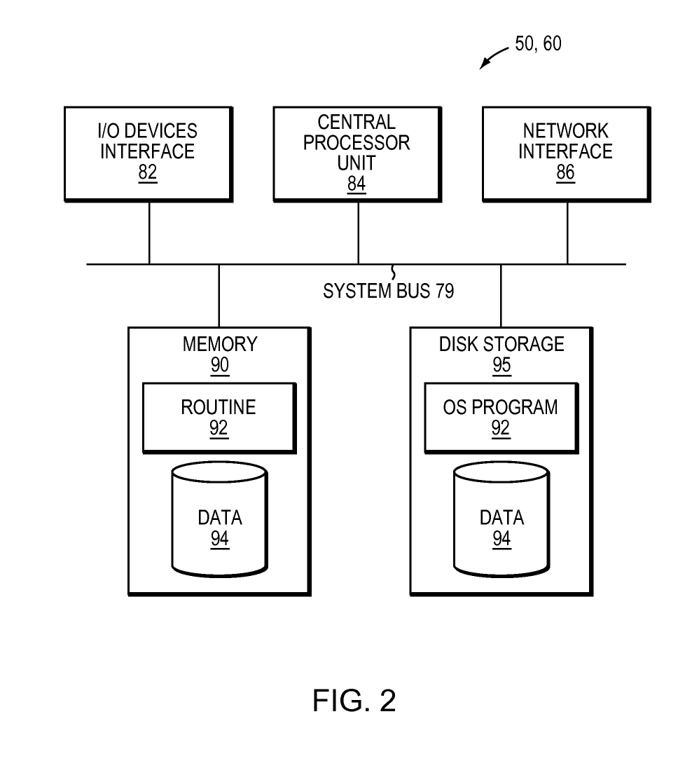

FIG. 2 is a diagram of the internal structure of a computer (e.g., client processor/device 50 or server computers 60) in the computer system of FIG. 1. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 1). Memory 90 provides volatile storage for computer software instructions 92 and data 94 used to implement an embodiment of the present invention (e.g., user interface 13, indicators 15, recommendation scores 17/engine and supporting code detailed below). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

In a preferred embodiment, the user interface 13 (e.g., at client 50) of the social networking site 21 displays an indicator 15, 17 of the relatedness between the client user and the person who is being shown in the user interface. For example, the client user 50 is viewing a page (screen view) of the social networking site 21. The viewed page is formed of content composed or otherwise authored by another user (the author-user). The invention user interface 13 displays an indicator 15, 17 of the relatedness between the user 50 and the author-user.

In another example, the client user 50 views another user's profile in a screen view/page. The invention user interface 13 displays an indicator 15, 17 of the relatedness between the user 50 and the profiled user.

In another example, the client user 50 is viewing a page (screen view) 25 of the social networking site 21 that has a comment by another user. The invention user interface 13 indicates (e.g., visually by displaying an indicator 15, 17) the relatedness between the user 50 and the commenting user (i.e., user who authored the comment).

In another example, the client user 50 views a screen view/page that has a list of user activities by various, different users. The invention user interface 13 displays or otherwise provides an indication of the relatedness between user 50 and a user named in the subject list.

In a further example, the client user 50 views a content collection page of the social networking site 21. The content collection page shows various and different authors, for example by name, photo/image and the like. The invention user interface 13 displays indicia or otherwise provides an indication of relatedness between user 50 and one of the authors shown on the content collection page being viewed.

The foregoing examples and other scenarios may be accomplished through any of the following means:

(a) Increasing the size of the name or picture of a user being indicated as related to client/viewing user 50 across the site 21, i.e.,
photos/images or names of users who are more closely related could be shown with a larger image or larger font size;
photos/images or names of users who are recommended could be shown with a larger image or larger font size, or with a different shape of their image (e.g., a circle), or a different text treatment of their font (e.g., italics) as compared to non-recommended users.

(b) Displaying an icon next to a user's name or picture across the site to indicate they are within a certain degree of relatedness, or are recommended (such as a star, symbol, etc).

(c) Displaying a numerical or verbal relatedness score as a decorator of the image or text of the other person.

FIGS. 3A-3B illustrate some sample indicators 15, 17 across multiple locations on a web page/page view 25 of invention user interface 13. FIG. 3A shows a gauge 15 indicating through color and level of fill how related the viewer of this photo is to the owner of the photo 23. Likewise, the same indicator (fillable gauge) 15 can be used in the user interface 13 to decorate comments 27 from people on the same page 25 as shown in the lower left and exploded portion of FIG. 3A. Alternatively, the user interface 13 can also include numerical values for relatedness or recommendation strength/score 17 as illustrated in FIG. 3B. The collection of recommendation scores 17 gives a sense of relative relatedness or connectedness.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above and below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

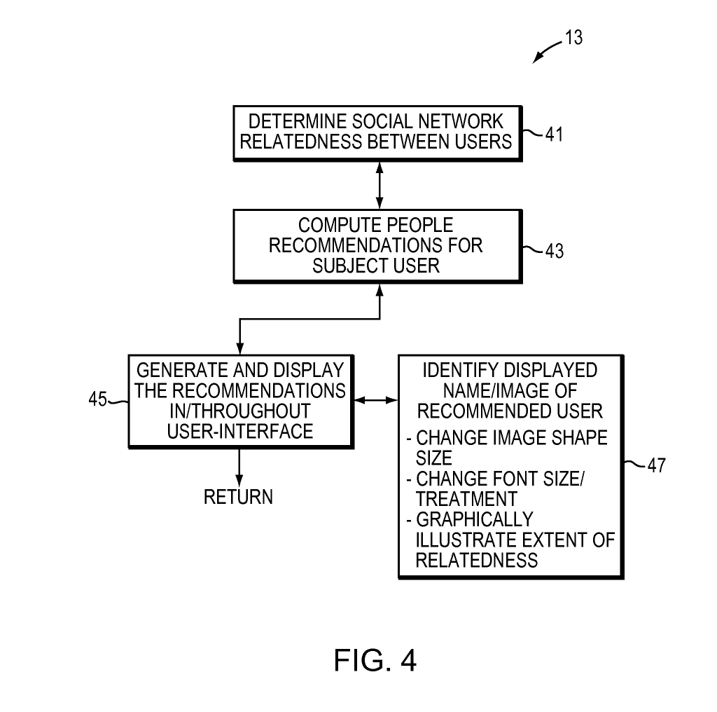

Referring now to FIG. 4, a flow diagram of one user interface 13 embodying the present invention is shown. Conventional configuration and functioning of user interface 13 are employed to enable an end-user 50 to navigate and operate screen views/pages 25 of subject social networking site 21. The user interface 13 operations for navigating within and across pages/screen views 25 include requesting/retrieving pages, changing pages to a next or previous in a series, scrolling content, linking to other content, and the like. Common or known techniques are utilized to implement these aspects of user interface 13.

In addition, user interface 13 makes people recommendations and consistently displays indications of these recommendations. The user interface 13 (step 41) employs known algorithms and techniques to determine social network relatedness between the users/members of the social networking site 21. One way that step 41 determines network-relatedness is by analyzing the “friend” or “connection” records of the social-networking site 21, and using that information to determine whether the current user has a direct link to the user whose content is currently being viewed. Step 41 may employ additional algorithms to determine less direct relationships, such as “friend of a friend” or “one degree of separation.” Such network based algorithms can represent relatedness information as being the number of people (“nodes”) along the shortest social-networking path between the user and person whose content is viewed (for example, a value of “0” is a direct connection, value of “1” indicates a connection with at least one person who has a connection to the person whose content is viewed, etc). Still other algorithms, such as content-based algorithms may be used at step 41 to determine similarity scores between pairs of users based on the number of words/terms/topics or other content the two users have in common.

The invention system 13 may continually perform or re-perform step 41 to update and refresh relatedness aspects among and between users.

Next step 43 of user interface 13 uses the results of step 41 and computes people recommendations for a subject user (i.e., client user 50). Common or known techniques may be utilized by step 43 for computing these recommendations. For example, step 43 may create recommendations only where the relatedness from step 41 is above a certain threshold. Step 43 may be continually performed.

In response, step 45 generates and displays (renders) the computed recommendations throughout the user interface 13 as exemplified in FIGS. 3A-B and discussed above. Step 45 may render visual indications (indicators 15, 17), audible indications, combinations thereof and so forth to provide user relatedness information throughout the user interface 13. Step 45 renders indicators 15 at each instance or occurrence (location) of the recommended person's name appearing on the displayed screen view/page 25 and at each instance/occurrence (location) of the recommended person's image appearing on the displayed page/screen view 25. To accomplish this, procedure 47 identifies a displayed name and/or image of the recommended user. For each such identified name/image, procedure 47 changes the image shape or size and/or changes the font size or font treatment (i.e., italics, bolding, etc.). Further procedure 47 may graphically illustrate extent of relatedness such as using a color scheme or fillable gauge 15 or the like. Similarly, procedure 47 may illustrate relative extent of relatedness using recommendation scores 17 and rendering the scores at each instance of pertinent images of respective recommended users.

Other indicators and rendering schemes (format, assemblies, procedure/protocol, and the like) are suitable.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

While this invention has been particularly shown and described with references to example embodiments thereof, it will be understood by those skilled in the art that various changes in form and details may be made therein without departing from the scope of the invention encompassed by the appended claims.

What is claimed is:

1. A computer system comprising:
a user interface enabling user navigation in a computerized social networking site; and
an indicator indicating user relatedness information between a given user and other people of the social networking site, the user interface employing the indicator in a manner consistently making people recommendations to the given user.

2. A computer system as claimed in claim 1 wherein the indicator is any combination of a visual indication and an audible indication.

3. A computer system as claimed in claim 1 wherein the indicator includes any of:
a symbol, a graphical illustration, and a recommendation score.

4. A computer system as claimed in claim 3 wherein the graphical illustration is a fillable gauge or bar type graph.

5. A computer system as claimed in claim 3 wherein the indicator includes colorizing.

6. A computer system as claimed in claim 1 wherein the indicator includes changing size of a displayed element in a page displayed by the social networking site.

7. A computer system as claimed in claim 6 wherein the displayed element is any of image and text.

8. A computer system as claimed in claim 1 wherein the indicator includes changing shape or border of a displayed element.

9. A computer system as claimed in claim 1 wherein the indicator includes changing text treatment of displayed text.

10. A computer system as claimed in claim 1 wherein the indicator includes indicating degree of or extent of user connectedness to other people in the social networking site.

11. A computer method comprising:
using a user interface enabling user interaction with a computerized social networking site; and
providing an indicator indicating user relatedness information between a given user and other people of the social networking site, including employing the indicator in the user interface in a manner consistently making people recommendations to the given user.

12. A computer method as claimed in claim 11 wherein the indicator is any combination of a visual indication and an audible indication.

13. A computer system as claimed in claim 11 wherein the indicator includes any of:
a symbol, a graphical illustration, and a recommendation score.

14. A computer system as claimed in claim 13 wherein the graphical illustration is a fillable gauge or bar type graph.

15. A computer system as claimed in claim 13 wherein the indicator includes colorizing.

16. A computer system as claimed in claim 11 wherein the indicator includes changing size of a displayed element in a page displayed by the social networking site.

17. A computer system as claimed in claim 16 wherein the displayed element is any of image and text.

18. A computer system as claimed in claim 11 wherein the indicator includes changing shape or border of a displayed element.

19. A computer system as claimed in claim 11 wherein the indicator includes changing text treatment of displayed text.

20. A computer system as claimed in claim 11 wherein the indicator includes indicating degree of or extent of user connectedness to other people in the social networking site.

21. Computer program product for recommending people in a computerized social networking site, the computer program product comprising:
a computer readable storage medium having computer readable program code embodied therewith, the computer readable program code comprising:
computer readable program code configured to provide an indicator indicating user relatedness information between a given user and other people of the social networking site, including employing the indicator in a user interface in a manner consistently making people recommendations to the given user throughout a given page and throughout pages of the social networking site.
